(19) United States
(12) Patent Application Publication
(10) Pub. No.: US 2010/0143672 A1
(43) Pub. Date: Jun. 10, 2010

(54) HOUSING

(75) Inventors: WEI LI, Shenzhen City (CN); ZHONG-CHENG WU, Shenzhen City (CN); ZHANG-QI LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/548,003

(22) Filed: Aug. 26, 2009

(30) Foreign Application Priority Data
Dec. 10, 2008 (CN) 200810306083.1

(51) Int. Cl. B32B 3/10

(52) U.S. Cl. 428/201; 428/195.1

(57) ABSTRACT

A housing comprises a transparent substrate, a first patterned layer and a second patterned layer. The transparent substrate layer includes a first surface and a second surface opposite to the first surface. The first patterned layer is laminated with the transparent substrate partially over the first surface of the transparent substrate. The first patterned layer includes a plurality of spaced first strip patterns such that a first interval space is defined between adjacent two first strip pattern. The second patterned layer is laminated with the transparent substrate partially over the second surface of the transparent substrate, the second patterned layer includes a plurality of spaced second strip patterns corresponding to the first strip patterns. Viewing from the first surface, the second strip patterns are partially exposed by corresponding first interval spaces.

This application is related to co-pending U.S. patent applications (Attorney Docket No. US22319), entitled “FILM AND HOUSING USING THE FILM”, by Cheng-Wen Su et al. Such applications have the same assignee as the present application and has been concurrently filed herewith. The above-identified applications are incorporated herein by reference.

### BACKGROUND

1. Technical Field

The exemplary disclosure generally relates to housings, and particularly to housings with three-dimensional pattern.

2. Description of Related Art

Portable electronic devices (such as mobile telephones and electronic notebooks) are in widespread use. The external appearance of the housing of the portable electronic device has become a key factor for attracting consumers.

Typically, a three-dimensional pattern is formed on the housing by laser holography, to improve the external appearance of the housing. However, the three-dimensional pattern of the housing made by said method, cannot meet the requirement of attractive appearance of the housing.

Thus, there is room for improvement within the art.

### BRIEF DESCRIPTION OF THE FIGURE

Many aspects of the embodiments can be better understood with references to the figures. The components in the figures are not necessarily drawn to scale, the emphasis instead being placed upon clearly illustrating the principles of the exemplary housing. Wherever possible, the same reference numbers are used throughout the figures to refer to the same or like elements of an embodiment.

FIG. 1 is a partial cross-section view of an exemplary embodiment of a housing including a transparent substrate, a first patterned layer, a second patterned layer.

FIG. 2 is a partial cross-section view of an another exemplary embodiment of a housing including a transparent substrate, a first patterned layer, a second patterned layer, a shading layer, and a protecting layer.

### DETAILED DESCRIPTION

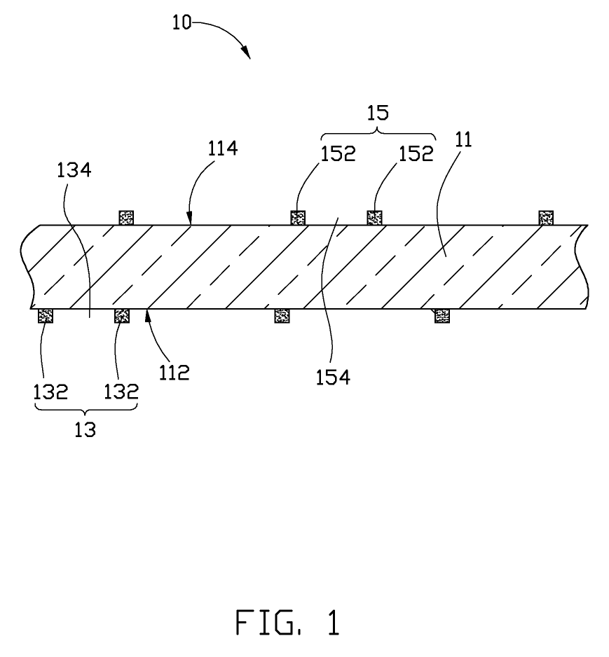

The FIG. 1 depicts an exemplary embodiment of a housing 10 that includes a transparent substrate 11, a first patterned layer 13 and a second patterned layer 15. The transparent substrate 11 includes a first surface 112 and a second surface 114 opposite to the first surface 112. The first patterned layer 13 is laminated with the transparent substrate 11 partially over the first surface 112 of the transparent substrate 11. The second patterned layer 15 is laminated with the transparent substrate 11 partially over the second surface 114 of the transparent substrate 113.

The first patterned layer 13 has a plurality of first patterns. In this embodiment, the first patterned layer 13 includes a plurality of spaced first strip patterns 132. Adjacent first strip patterns 132 define a first interval space 134 therebetween. The second patterned layer 15 includes a plurality of spaced second strip patterns 152 corresponding to the first strip patterns 132. Between each second strip pattern 152 and another nearest second strip pattern 152 has a second interval space 154.

In this exemplary embodiment, part of the second strip patterns 152 partially overlap with first strip patterns 132 and the rest of the second strip patterns 152 are partially overlapped with corresponding first interval spaces 134, so that the first strip patterns 132 and the second strip patterns 152 are exposed simultaneously in the direction perpendicular to the transparent substrate 11. The first interval spaces 134 are partially overlapped with corresponding second interval spaces 154. In other words, the first interval spaces 134 are partially aligned with the second interval spaces 154. Thus, light transmitted to the transparent substrate 11 is partially reflected by the second strip patterns 152, and passes through the transparent substrate 11 toward the first strip patterns 132. Then, the light passing through the transparent substrate 11 is reflected by the first strip patterns 132 and is reversely transmitted back into the transparent substrate 11. When the light reflected by the first strip patterns 132 travels to the second surface 114 of the transparent substrate 11, the light reflected by the first strip patterns 132 is refracted because the second surface 114 acts as an interface between the transparent substrate 11 and air, or acts as an interface between the transparent substrate 11 and the protecting layer 19. Therefore, light reflected by the first strip pattern 132 and light reflected by the second strip patterns 152 interacts at the second surface 114, and light reflected by the first strip patterns 132 is refracted at the second surface 112, thus producing a three-dimensional and dynamic appearance of the housing 10.

The material for the transparent substrate 11 may be a resin sheet of a single body or a copolymer of a polypropylene, polyamide, polycarbonate, polymethyl methacrylate et al. The transparent substrate 11 may have a thickness of 0.5 millimeters (mm) to 2 mm.

As a material for the first patterned layer 13 and the second patterned layer 15 is selected from a resin such a polyvinyl based resin, a polyamide based resin, a polyester based resin, an acrylic resin, a polyurethane based resin, apolyvinyl acetal based resin, a cellulose ester based resin. It is understood that the first patterned layer 13 and the second patterned layer 15 may also be an alkyd resin as a binder and employ a coloring ink that contains a pigment or dye as a coloring as a coloring agent. Either or both of the first patterned layer 13 and the second patterned layer 15, may be formed using ordinary printing methods, such as the gravure printing method, the screen printing method or the offset printing method.

It is understood that the first strip patterns 132 of the first patterned layer 13 may be partially off-set with the second strip patterns 152 of the second patterned layer 15. That is to say, the second strip patterns 152 of the second patterned layer 15 is only overlapped with the first interval spaces 134 of the first patterned layer 13. At this case, the light transmitted to the transparent substrate 11 also can be partially reflected by the first strip patterns 132, and passes through the transparent substrate 11 toward the second strip patterns 152.

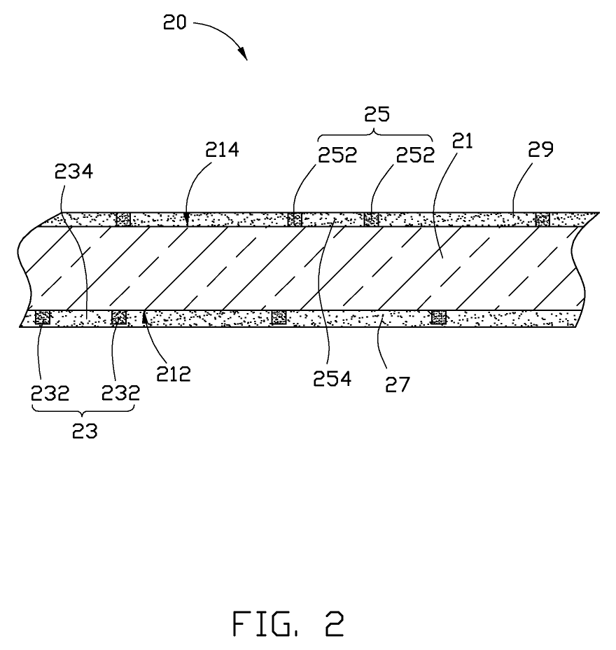

Referring to FIG. 2, another exemplary housing 20 includes a transparent substrate 21, a first patterned layer 23, a second patterned layer 25, a shading layer 27 and a protecting layer 29. The transparent substrate 21 includes a first surface 212 and a second surface 214 opposite to the first surface 212. The first patterned layer 23 is laminated with the transparent substrate 21 partially over the first surface 212 of the transparent substrate 21. The second patterned layer 25 is laminated with the transparent substrate 21 partially over the second surface 214 of the transparent substrate 213.

The shading layer 27 is laminated with the transparent substrate 21 entirely over the entire first surface 212 and covering the first patterned layer 23, if the transparent substrate 21 is needed to prevent light emitted via the second surface 214 from entering the first surface 212. The shading layer 27 can be made of an opaque, black color material (e.g., the mixture of resin and carbon). The protecting layer 29 is laminated with the transparent substrate 21 entirely over the entire second surface 214 and covering the second patterned layer 25, if the transparent substrate 21 is needed to protect the second patterned layer 25 from abrasion. The protecting layer 29 may be ink having good abrasion resistance.

The material for the transparent substrate 21 may be a resin sheet of a single body or a copolymer of a polypropylene, polyamide, polycarbonate, polymethyl methacrylate et al. The transparent substrate 21 may have a thickness of 0.5 millimeters (mm) to 2 mm.

The first patterned layer 23 has a plurality of first patterns. In this embodiment, the first patterned layer 23 includes a plurality of spaced first strip patterns 232. Adjacent first strip patterns 232 define a first interval space 134 therebetween. The second patterned layer 25 includes a plurality of spaced second strip patterns 252 corresponding to the first strip patterns 232. Between each second strip pattern 252 and another nearest second strip pattern 252 has a second interval space 254.

In this exemplary embodiment, part of the second strip patterns 252 partially overlap with first strip patterns 232 and the rest of the second strip patterns 252 are partially overlapped with corresponding first interval spaces 234, so that the first strip patterns 232 and the second strip patterns 252 are exposed simultaneously in the direction perpendicular to the transparent substrate 21. The first interval spaces 234 are partially overlapped with corresponding second interval spaces 254. In other words, the first interval spaces 234 are partially aligned with the second interval spaces 254. Thus, light transmitted to the transparent substrate 21 is partially reflected by the second strip patterns 252, and passes through the transparent substrate 21 toward the first strip patterns 232. Then, the light passing through the transparent substrate 21 is reflected by the first strip patterns 232 and is reversely transmitted back into the transparent substrate 21. When the light reflected by the first strip patterns 232 travels to the second surface 214 of the transparent substrate 21, the light reflected by the first strip patterns 232 is refracted because the second surface 214 acts as an interface between the transparent substrate 21 and air, or acts as an interface between the transparent substrate 21 and the protecting layer 29. Therefore, light reflected by the first strip pattern 232 and light reflected by the second strip patterns 252 interacts at the second surface 214, and light reflected by the first strip patterns 232 is refracted at the second surface 212, thus producing a three-dimensional and dynamic appearance of the housing 20.

As a material for the first patterned layer 23 and the second patterned layer 25 is selected from a resin such a polyvinyl based resin, a polyamide based resin, a polyester based resin, an acrylic resin, a polyurethane based resin, apolyvinyl acetal based resin, a cellulose ester based resin. It is understood that the first patterned layer 23 and the second patterned layer 25 may also be an alkyd resin as a binder and employ a coloring ink that contains a pigment or dye as a coloring as a coloring agent. Either or both of the first patterned layer 23 and the second patterned layer 25, may be formed using ordinary printing methods such as the gravure printing method, the screen printing method or the offset printing method.

It is to be understood, however, that even though numerous characteristics and advantages of the exemplary disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing comprising:
a transparent substrate, the transparent substrate layer including a first surface and a second surface opposite to the first surface;
a first patterned layer, the first patterned layer laminated with the transparent substrate partially over the first surface of the transparent substrate, the first patterned layer including a plurality of spaced first strip patterns such that a first interval space is defined between adjacent two first strip pattern; and
a second patterned layer, the second patterned layer laminated with the transparent substrate partially over the second surface of the transparent substrate, the second patterned layer including a plurality of spaced second strip patterns corresponding to the first strip patterns;
wherein viewing from the first surface of the transparent substrate, the second strip patterns are partially exposed by corresponding first interval spaces.

2. The housing of claim 1, wherein the transparent substrate is made of a resin sheet of a single body or a copolymer of a polypropylene, polyamide, polycarbonate, polymethyl methacrylate.

3. The housing of claim 1, wherein the transparent substrate has a thickness of approximately 0.5 to 2 mm.

4. The housing of claim 1, wherein the first patterned layer and the second patterned layer both of which are made of a resin such a polyvinyl based resin, a polyamide based resin, a polyester based resin, an acrylic resin, a polyurethane based resin, apolyvinyl acetal based resin, a cellulose ester based resin, or an alkyd resin as a binder and employ a coloring ink that contains a pigment or dye as a coloring agent.

5. The housing of claim 1, wherein the housing further includes a protecting layer laminated with the transparent substrate entirely over the first surface and covering the first patterned layer.

6. The housing of claim 5, wherein the protecting layer is an ink having good abrasion resistance.

7. The housing of claim 1, wherein the housing further includes a shading layer laminated with the transparent substrate entirely over the second surface and covering the second patterned layer.

8. The housing of claim 7, wherein the shading layer be made of an opaque material.

9. The housing of claim 7, wherein the shading layer is made of the mixture of resin and carbon.

10. A housing comprising:
a transparent substrate, the transparent substrate including a first surface and a second surface opposite to the first surface;
a first patterned layer, the first patterned layer formed on the first surface of the transparent substrate and having a plurality of first patterns; and
a second patterned layer, the second patterned layer formed the transparent substrate and having forming a plurality of second patterns;
wherein the first patterns of the first patterned layer are partially off-set with corresponding second patterns of the second patterned layer.

11. The housing of claim 10, wherein at least one of the first pattern and the second pattern includes spaced strips.

12. The housing of claim 10, wherein the transparent substrate has a thickness of approximately 0.5 to 2 mm.

13. The housing of claim 10, wherein the housing further includes a protecting layer laminated with the transparent substrate entirely over the first surface and covering the first patterned layer.

14. The housing of claim 13, wherein the protecting layer is an ink having good abrasion resistance.

15. The housing of claim 10, wherein the housing further includes a shading layer laminated with the transparent substrate entirely over the second surface and covering the second patterned layer.

16. The housing of claim 15, wherein the shading layer be made of an opaque material.

17. The housing of claim 15, wherein the shading layer be made of the mixture of resin and carbon.

18. The housing of claim 1, wherein the first patterned layer and the second patterned layer both of which are made of a resin such a polyvinyl based resin, a polyamide based resin, a polyester based resin, an acrylic resin, a polyurethane based resin, apolyvinyl acetal based resin, a cellulose ester based resin, or an alkyd resin as a binder and employ a coloring ink that contains a pigment or dye as a coloring as a coloring agent.
